(19) United States
(12) Patent Application Publication
(10) Pub. No.: US 2007/0095517 A1
(43) Pub. Date: May 3, 2007

(54) Multi-zone air conditioning system for a motor vehicle

(76) Inventor: Matthias Schall, Stuggart (DE)

Correspondence Address: FOLEY AND LARDNER LLP;SUITE 500, 3000 K STREET NW, WASHINGTON, DC, 20007, US

(21) Appl. No.: 10/583,972

(22) PCT Filed: Dec. 14, 2004
(86) PCT No.: PCT/EP04/14230

§ 371 Date: Jun. 22, 2006

(30) Foreign Application Priority Data
Dec. 22, 2003 (DE) 103 61 111.8

(51) Int. Cl. B60H 1/00; B61D 27/00

(52) U.S. Cl. 165/204; 165/41; 454/75; 454/107

(57) ABSTRACT

The invention relates to an air conditioning system (1) for a motor vehicle comprising several zones, an air-flow compensation device (12) being located between at least two of the individual zones and to a method for regulating a multi-zone air conditioning system comprising an air-flow compensation device.

The invention relates to a multi-zone air conditioning system for a motor vehicle according to the precharacterizing clause of claim 1 and to a method for regulating a multi-zone air conditioning system for a motor vehicle according to claim 14.

Air conditioning systems of this type have a plurality of zones. These zones are formed by a division of the air conditioning unit to provide individual regulation of the air temperature within the respective zone. The air which is temperature-controlled in a respective zone of the air conditioning system is subsequently directed by means of air ducts into the corresponding space region of the vehicle in order to bring about individual air conditioning in the respective space regions.

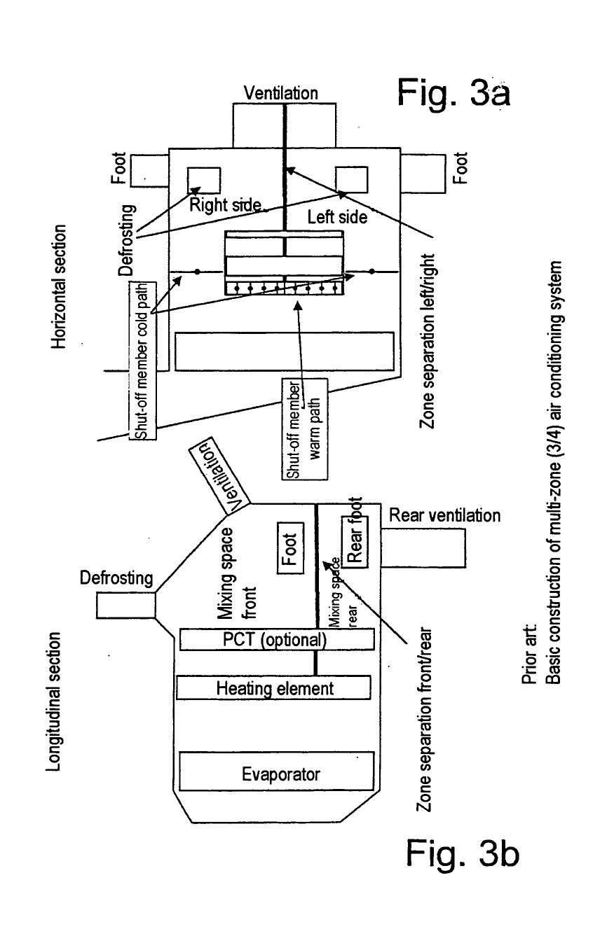

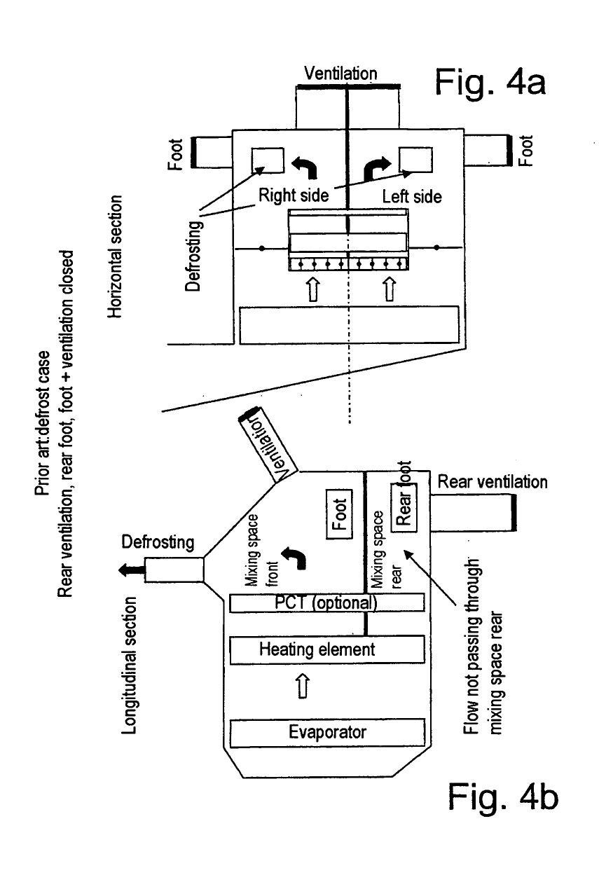

In the case of conventional air conditioning systems for a motor vehicle, for example in the case of 3- and 4-zone air conditioning systems, as illustrated in FIGS. 3a and 3b, operating situations may arise in which the flow does not pass through part of the air conditioning system. This leads in general to a reduction in the possible quantity of air and possibly also to losses in the capacity, i.e. in the heating or refrigerating capacity, since the possible flow cross sections are not fully utilized. Furthermore, poorer acoustics may occur due to the higher pressure drops on the air side. This may be the case, for example, in the defrosting of the windows (defrost mode) illustrated in FIGS. 4a and 4b. In this case, all of the air ducts apart from the duct or the two or more ducts leading to the defrosting of the windshield are usually closed. In this situation, in addition to the quantity of air the heating capacity is also reduced, since only part of the flow on the air side passes through the heating element, as illustrated in FIG. 4b.

It is the object of the invention to provide an improved air conditioning system.

This object is achieved by a multi-zone air conditioning system for a motor vehicle with the features of claim 1. Advantageous refinements are the subject matter of the subclaims.

According to the invention, an air conditioning system for a motor vehicle with a plurality of air conditioning zones is provided, said air conditioning system having an air-flow compensation device which is provided between at least two of the individual zones. In particular, three- and four-zone air conditioning systems are suitable here. In certain operating states, preferably in the defrost mode, in which the flow does not pass through subregions of conventional air conditioning systems, the air-flow compensation device makes it possible for the flow to be able also to pass through these subregions if possible and expedient, with the result that the available flow cross section is increased. This permits, inter alia, an improved capacity, in particular an increased quantity of air, and better heating or refrigerating capacity. Owing to the reduced pressure drop on the air side, possibly occurring noises are also reduced in the corresponding operating state.

The air-flow compensation device is preferably formed by at least one air-flow control element, for example a flap, which can open and close a region of a partition between two zones, preferably between mixing spaces or air ducts for the front region and the rear region. The flaps may be designed, for example, in single-wing form (flag-type flaps), double-wing form (butterfly flaps) or as a flap arrangement of a plurality of individual flaps.

Louver-type flaps or rolling-belt cassettes prove to be further advantageous embodiments, with rolling-belt cassettes being understood as meaning subassemblies comprising a drive shaft and a deflecting shaft on which an endless belt is guided, the belt closing or partially or fully opening passage openings for air.

As an alternative, a bypass may also be provided between the corresponding zones, this bypass preferably being able to be regulated by means of flaps. Other air-flow compensation devices are possible, such as, for example, displaceable and/or elastically deformable partitions. In an extreme situation, for example, the entire partition may also serve as the flap.

The air-flow compensation device makes provision for the possibility of changing the flow surfaces through which the flow can pass in individual operating states, with, preferably, a flow surface assigned to the rear region of the motor vehicle being added, if the need arises, with the aid of the air-flow compensation device to the flow surface assigned in normal operation to the front region of the motor vehicle.

In a further refinement of the invention, the air-flow compensation device is designed in such a manner that the zone separation between three or four of the individual zones is eliminated. The compensation device advantageously has at least two air-flow control elements and/or bypasses.

The invention is explained in detail below using two exemplary embodiments and with reference to the drawing, in which:

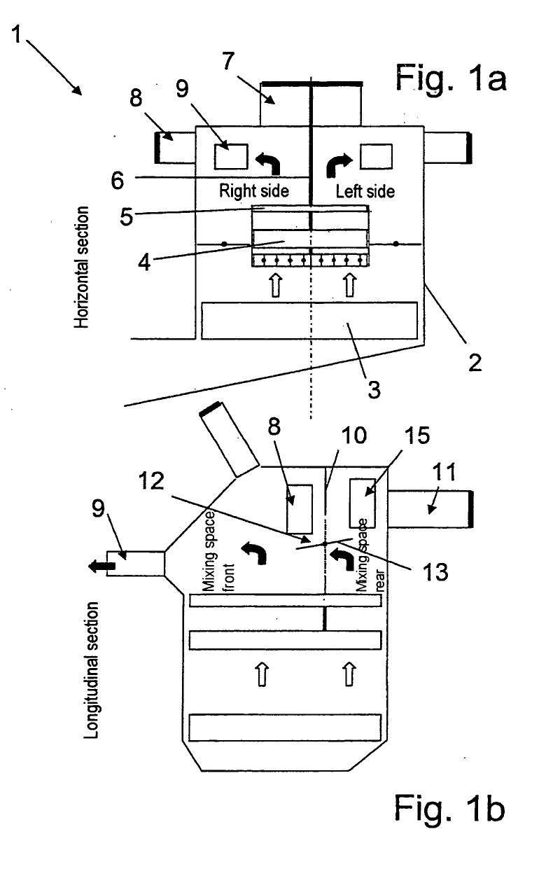

FIGS. 1a and 1b show sections in the horizontal direction (FIG. 1a) and in the longitudinal direction (FIG. 1b) through a first exemplary embodiment in the defrost mode,

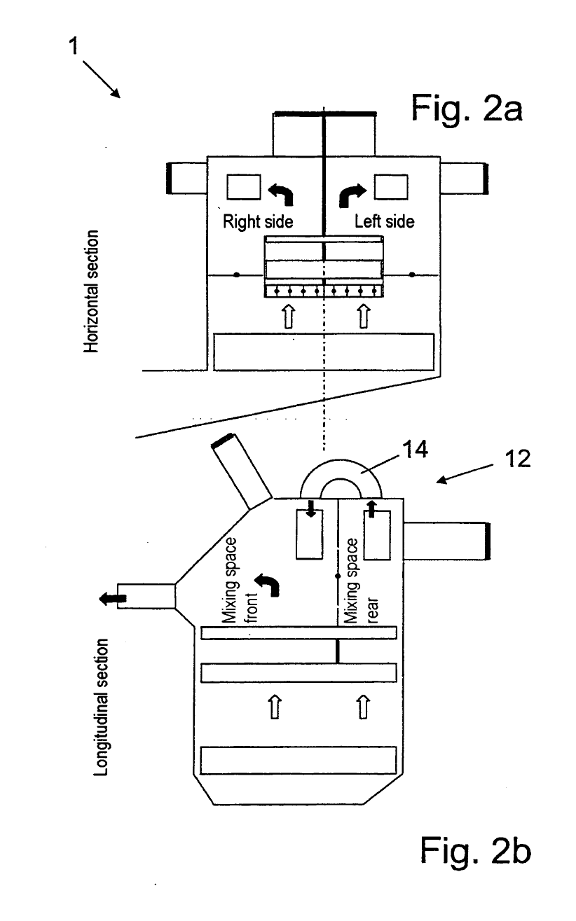

FIGS. 2a and 2b show sections in the horizontal direction (FIG. 2a) and in the longitudinal direction (FIG. 2b) through a second exemplary embodiment in the defrost mode,

FIGS. 3a and 3b show sections in the horizontal direction (FIG. 3a) and in the longitudinal direction (FIG. 3b) through a multi-zone air conditioning system for a motor vehicle according to the prior art in order to illustrate the basic construction, and

FIGS. 4a and 4b show sections in the horizontal direction (FIG. 4a) and in the longitudinal direction (FIG. 4b) through the air conditioning system of FIGS. 3a and 3b in the defrost mode,

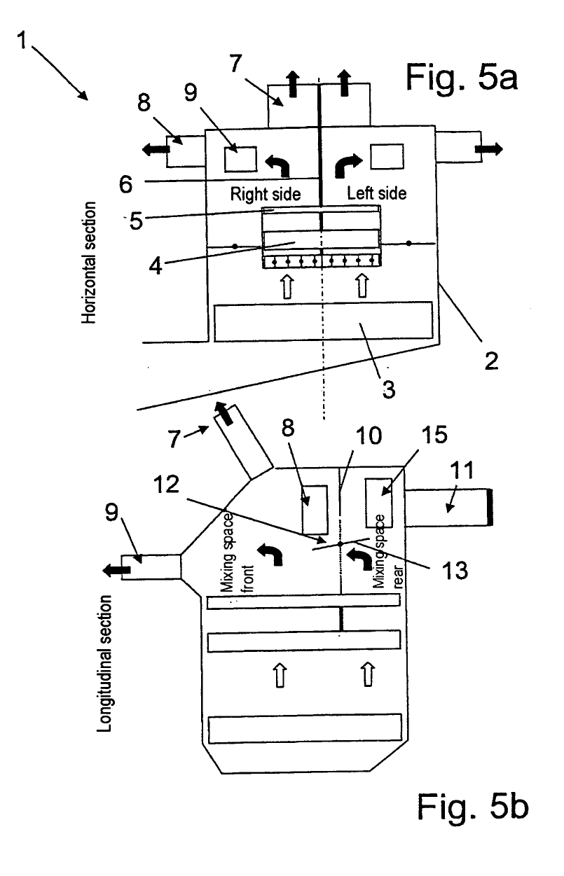

FIGS. 5a and 5b show sections in the horizontal direction (FIG. 5a) and in the longitudinal direction (FIG. 5b) through an exemplary embodiment of a blocked rear ventilation,

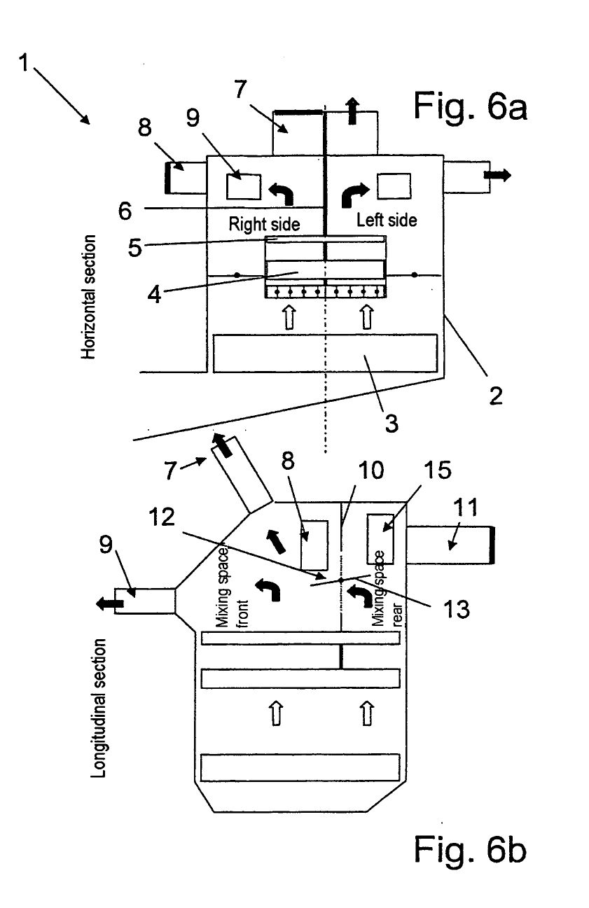

FIGS. 6a and 6b show sections in the horizontal direction (FIG. 5a) and in the longitudinal direction (FIG. 5b) through an exemplary embodiment with a blocked rear and front-passenger ventilation.

A first exemplary embodiment of a multi-zone air conditioning system 1 for a motor vehicle with an evaporator 3 arranged in a housing 2, a heating element 4 and an (optional) additional heater 5 is explained with reference to FIGS. 1a and 1b. The air coming from a fan (not illustrated) is conducted through the evaporator 3 and—depending on requirements—all or some of the air is passed through the heating element 4 and optional additional heater 5.

As is apparent from FIG. 1a, the air conditioning system 1 is of symmetrical design in the region of the mixing space, with a longitudinal partition 6 being formed in the plane of symmetry, so that a zone separation into the two halves of the vehicle is possible. Starting from the two halves, a respective air duct 7 is provided for the interior ventilation, i.e. the central and side nozzles, an air duct 8 for the foot wells and an air duct 9 for defrosting the windshield. Further optional air ducts, for example in the direction of the B-pillar or the parcel shelf, are not illustrated. Furthermore, a second partition 10 for the separation into the front region and rear region is provided transversely to the longitudinal partition 6, as is apparent from FIG. 1b. An air duct 11 for the rear ventilation and an air duct 15 for the rear footwell branch off from that region of the mixing space which is illustrated on the right in FIG. 1b.

In order as fully as possible to use the possible flow cross section in the defrost mode, in which all of the other air ducts apart from the two air ducts 9, i.e. the air ducts 11 and 15 for the rear region are closed, an air-flow control element 13, here in the form of a flap, is provided as air-flow compensation device 12 in the partition 10 and is opened in the defrost mode. This makes it possible for that part of the mixing space which is actually provided for the rear region to also be available as a flow surface.

According to the second exemplary embodiment illustrated in FIGS. 2a and 2b, a bypass air duct 14 formed in the housing 2 is provided from the rear mixing space to the front mixing space and serves as air-flow compensation device 12. The bypass air duct 14 can be regulated by means of flaps (not illustrated), with the function of the same corresponding to that of the flap 13 of the first exemplary embodiment. The construction of the air conditioning system for a motor vehicle otherwise corresponds to that of the first exemplary embodiment previously described.

In a further exemplary embodiment illustrated in FIGS. 5a and 5b, all of the air ducts 11 and 15 for the rear region are closed. In contrast to the exemplary embodiment illustrated in FIGS. 1a and 1b, in addition to the air ducts 9 for the defrost mode the air ducts 7 for the interior ventilation and the air ducts 8 for the foot wells of the front region are also opened. Therefore, only ventilation of the front region of the vehicle interior takes place. In order to utilize the entire space of the air conditioning system 1 or the flow cross section of the heat exchangers 3, 4 and 5 and to increase the quantity of air passing through, an air-flow control element 13 is provided in the partition 10 and permits the passage of the air from the rear mixing space, the outlets of which are closed, to the front mixing space. As an alternative or in addition to the air-flow control element 13, a bypass air duct 14 can also be provided between rear and front mixing spaces. In principle, for example, a three- or four-zone air conditioning system can thus be switched over into a two-zone air conditioning system. This switching-over can be undertaken, for example, manually by a vehicle occupant in the front space or else automatically by means of a seat occupation recognition device, for example in the form of one or more pressure sensors in the occupants' seats.

In a development, in the exemplary embodiment illustrated in FIGS. 5a and 5b, in addition to the air ducts in the rear region 11 and 15 the air ducts for ventilation on the front-passenger side 7 and 8 can also be closed, as illustrated in FIGS. 6a and 6b. The entire air flow of the air conditioning system can then be made available on the driver's side via a correspondingly opened compensation device 12 with all of the zone separations being eliminated. Thus, in a limiting situation, a single-zone air conditioning system 1 is produced from the multi-zone air conditioning system 1.

### List of Reference Numbers

1 Air conditioning system for a motor vehicle
2 Housing
3 Evaporator
4 Heating element
5 Additional heater
6 Longitudinal partition
7 Air duct (central and size nozzles)
8 Air duct (footwell front)
9 Air duct (defrost)
10 Partition
11 Air duct (rear region)
12 Air-flow compensation device
13 Air-flow control element
14 Bypass air duct
15 Air duct (footwell rear)

1. An air conditioning system for a motor vehicle, with a plurality of zones, characterized in that an air-flow compensation device (12) is provided between at least two of the individual zones.

2. The air conditioning system for a motor vehicle as claimed in claim 1, characterized in that the air-flow compensation device (12) is formed by at least one air-flow control element (13) which can open and close at least one region of a partition (10) between two zones.

3. The air conditioning system for a motor vehicle as claimed in claim 1 or 2, characterized in that the air-flow control element (13) is designed in the form of a flap or an arrangement of a plurality of flaps.

4. The air conditioning system for a motor vehicle as claimed in one of the preceding claims, characterized in that the air-flow control element (13) is formed from one or more flaps of the flag type.

5. The air conditioning system for a motor vehicle as claimed in one of the preceding claims, characterized in that the air-flow control element (13) is formed from one or more flaps of the butterfly type.

6. The air conditioning system for a motor vehicle as claimed in one of the preceding claims, characterized in that the air-flow control element (13) is formed from one or more louver-type flaps.

7. The air conditioning system for a motor vehicle as claimed in one of the preceding claims, characterized in that the air-flow control element (13) is formed from one or more rolling-belt cassettes.

8. The air conditioning system for a motor vehicle as claimed in claim 1 or 2, characterized in that the air-flow compensation device (12) is formed by at least one bypass (14) which is provided between two zones.

9. The air conditioning system for a motor vehicle as claimed in one of the preceding claims, characterized in that the air-flow compensation device (12) can be regulated.

10. The air conditioning system for a motor vehicle as claimed in one of the preceding claims, characterized in that the air-flow compensation device (12) makes provision for the flow surfaces through which the flow can pass in individual operating states to be able to be changed, with a flow surface assigned to the rear region of the motor vehicle being added, if the need arises, with the aid of the air-flow compensation device (12) to the flow surface assigned in normal operation to the front region of the motor vehicle.

11. The air conditioning system for a motor vehicle as claimed in one of the preceding claims, characterized in that the air-flow compensation device (12) is arranged between mixing spaces or air ducts for the front region and the rear region.

12. The air conditioning system for a motor vehicle as claimed in one of the preceding claims, characterized in that an air-flow compensation by means of the air-flow compensation device (12) is provided in the defrost mode.

13. The air conditioning system for a motor vehicle as claimed in one of the preceding claims, characterized in that the air conditioning system comprises at least one of the following components: heat exchanger, heating element, evaporator, filter, temperature mixing flap, mixing chamber, one or more flow ducts and one or more control flaps for distributing the air to the outlet ducts.

14. A method for regulating a multi-zone air conditioning system for a motor vehicle, characterized in that an air-flow compensation between at least two zones takes place in at least one operating state.

15. The method as claimed in claim 14, characterized in that the air-flow compensation takes place in the defrost mode.
